(19) United States
(12) Patent Application Publication
(10) Pub. No.: US 2026/0357713 A1
(43) Pub. Date: Nov. 12, 2026

(54) SYSTEMS AND METHODS FOR TIMELY ADDRESSING PARTICULATES IN A GAS TURBINE WITH A WASH SYSTEM

(71) Applicant: GE INFRASTRUCTURE TECHNOLOGY LLC, Greenville, SC (US)

(72) Inventors: Maruthi Manohar JUPUDI, Dubai (AE); Murali Krishna KALAGA, Karnataka (IN); Sanji EKANAYAKE, Atlanta, GA (US); Alston Ilford SCIPIO, Atlanta, GA (US); Kamel Abdelkader TAYEBI, Dammam (SA)

(21) Appl. No.: 19/130,788

(22) PCT Filed: Nov. 17, 2023
(86) PCT No.: PCT/US2023/080276

§ 371 Date: May 16, 2025

(30) Foreign Application Priority Data
Nov. 22, 2022 (IN) 202211067091

(51) Int. Cl. F01D 25/00; F01D 21/10

(52) U.S. Cl. CPC F01D 25/002; F01D 21/10; F05D 2260/607; F05D 2260/80; F05D 2270/80

(57) ABSTRACT

A method for timely addressing particulates in a gas turbine is provided. The gas turbine includes a compressor section, a combustion section, and a turbine section. The method includes monitoring, with a controller, data indicative of one or more particulate parameters with a particulate sensor. The particulate sensor is disposed in at least one of an inlet to the compressor section or an outlet of the turbine section. The method further includes determining, with the controller, when the data indicative of one or more particulate parameters exceeds a particulate threshold. The method further includes implementing a control action associated with a wash system in response to determining that the data indicative of one or more particulate parameters exceeds the particulate threshold.

### FIELD

The present disclosure relates generally to systems and methods for timely addressing particulates in a gas turbine with a wash system. More specifically, the present disclosure relates to performing a wash related event based on sensed particulate data in a gas turbine.

### BACKGROUND

Turbomachines are utilized in a variety of industries and applications for energy transfer purposes. For example, a gas turbine engine generally includes a compressor section, a combustion section, a turbine section, and an exhaust section. The compressor section progressively increases the pressure of a working fluid entering the gas turbine engine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases then exit the gas turbine via the exhaust section.

Gas turbines are used throughout the world in many diverse applications and environments. This diversity creates a number of challenges to air filtration systems, necessitating different particle accumulation estimates and/or estimates of effects on components of the gas turbine system for each type of environmental contaminant(s), gas turbine platform technology, and/or fuel quality. For example, gas turbines which operate in hot and harsh climates, in environments in which the turbine is exposed to severe air quality contaminations, and/or high efficiency gas turbines operating at high operational temperatures, face significant challenges with respect to engine performance, reliability, and/or maintainability, particularly where there is a compromise or breach in the inlet system of the gas turbine system. Such challenges may include the erosion, corrosion and/or failure of various turbine components.

Over time, the components of the gas turbine may degrade from use, accumulation of substances, or the like. For example, filters in a filter house of a turbine system may degrade by accumulating sand, dust, or other particles, thereby causing a pressure drop in an inlet duct structure that is undesirable. In another example, the compressor of a turbine system may also degrade by accumulating dust, thereby affecting the output of the turbine system. Additionally, when a combustion equipment burns ash-forming fuels, the ash or soot particles are transported by the combustion gases along the hot gas path and partly deposit on the hot parts, causing their progressive fouling.

In order to clean the various components of the gas turbine, cleaning events or a “water wash” of the components and subsystems may be statically scheduled. However, following a static schedule may lead to inefficient resource usage by shutting down the gas turbine before the components have actually reached a degraded state that affects the performance of the gas turbine. Additionally, the static scheduling may vary drastically depending on the operational environment of the gas turbine, e.g., a gas turbine in the desert would need to be washed more frequently due to the increased amount of sand and other particles.

As such, an improved system and method for reducing downtime in a gas turbine by actively responding to particulate data with a wash system is desired and would be appreciated in the art.

### BRIEF DESCRIPTION

Aspects and advantages of the methods and systems in accordance with the present disclosure will be set forth in part in the following description, or may be obvious from the description, or may be learned through practice of the technology.

In accordance with one embodiment, a method for timely addressing particulates in a gas turbine is provided. The gas turbine includes a compressor section, a combustion section, and a turbine section. The method includes monitoring, with a controller, data indicative of one or more particulate parameters with a particulate sensor. The particulate sensor is disposed in at least one of an inlet to the compressor section or an outlet of the turbine section. The method further includes determining, with the controller, when the data indicative of one or more particulate parameters exceeds a particulate threshold. The method further includes implementing a control action associated with a wash system in response to determining that the data indicative of one or more particulate parameters exceeds the particulate threshold.

In accordance with another embodiment, a system is provided. The system includes a gas turbine having a compressor section, a combustion section, and a turbine section. The system includes a wash system fluidly coupled to the gas turbine. The system further includes a particulate sensor disposed in at least one of an inlet to the compressor section or an outlet of the turbine section. The particulate sensor is configured to provide data indicative of one or more particulate parameters. The system further includes a controller communicatively coupled to the wash system and the particulate sensor. The controller includes a memory and at least one processor. At least one processor configured to perform a plurality of operations. The plurality of operations include monitoring, with the controller, data indicative of one or more particulate parameters with the particulate sensor. The plurality of operations further include determining, with the controller, when the data indicative of one or more particulate parameters exceeds the particulate threshold. The plurality of operations further include implementing a control action associated with a wash system in response to determining that the data indicative of one or more particulate parameters exceeds the particulate threshold.

These and other features, aspects and advantages of the present methods and systems will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present methods and systems, including the best mode of making and using the present systems and methods, directed to one of ordinary skill in the art, is set forth in the specification, which makes reference to the appended figures, in which:

FIG. 1 is a schematic illustration of a system that includes a turbomachine in accordance with embodiments of the present disclosure;

FIG. 2 illustrates a cross-sectional view of an inlet to a compressor section of a gas turbine is provided in accordance with embodiments of the present disclosure;

FIG. 3 illustrates a block diagram of the system shown in FIG. 1 is illustrated in accordance with embodiments of the present disclosure;

FIG. 4 illustrates a real time degradation/fouling advisor algorithm framework in accordance with an exemplary aspect of the present disclosure;

FIG. 5 illustrates a flow chart of for monitoring and responding to particulate ingress in a gas turbine in accordance with exemplary embodiments of the present disclosure;

FIG. 6 a block diagram of one or more aspects of a model for monitoring and responding to particulate ingress in a gas turbine is illustrated in accordance with embodiments of the present disclosure;

FIG. 7 illustrates a logic flow chart in accordance with one or more exemplary aspects of the present disclosure; and

FIG. 8 illustrates a flow diagram of a method for timely addressing particulates in a gas turbine in accordance with embodiments of the present disclosure.

### DETAILED DESCRIPTION

Reference now will be made in detail to embodiments of the present methods and systems, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

It should also be appreciated that, as used herein, the term “monitor” and variations thereof indicates that the various sensors of the system may be configured to provide a direct measurement of the parameters being monitored and/or an indirect measurement of such parameters.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

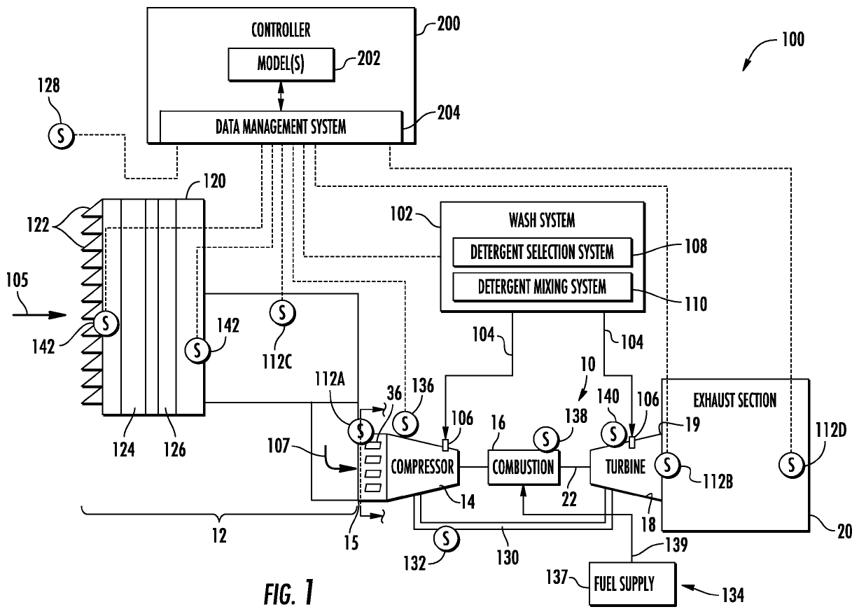

Referring now to the drawings, FIG. 1 illustrates a schematic diagram of one embodiment of a system 100, which includes a gas turbine 10. Although an industrial or land-based gas turbine is shown and described herein, the present disclosure is not limited to a land-based and/or industrial gas turbine unless otherwise specified in the claims. For example, the invention as described herein may be used in any type of turbomachine including but not limited to a steam turbine, an aircraft gas turbine, or a marine gas turbine.

As shown, gas turbine 10 generally includes, in a serial flow order, an inlet section 12, a compressor section 14 disposed downstream of the inlet section 12, a plurality of combustors (not shown) within a combustion section 16 disposed downstream of the compressor section 14, a turbine section 18 disposed downstream of the combustion section 16, and an exhaust section 20 disposed downstream of the turbine section 18. Additionally, the gas turbine 10 may include one or more shafts 22 coupled between the compressor section 14 and the turbine section 18.

During operation, a working fluid such as air flows through the inlet section 12 and into the compressor section 14 where the air is progressively compressed, thus providing pressurized air to the combustors of the combustion section 16. The pressurized air is mixed with fuel and burned within each combustor to produce combustion gases. The combustion gases flow through the hot gas path from the combustion section 16 into the turbine section 18, wherein energy (kinetic and/or thermal) is transferred from the combustion gases to the rotor blades, causing the shaft 22 to rotate. The mechanical rotational energy may then be used to power the compressor section 14 and/or to generate electricity. The combustion gases exiting the turbine section 18 may then be exhausted from the gas turbine 10 via the exhaust section 20.

In many embodiments the gas turbine 10 may include a series of inlet guide vanes (IGVs) 36 disposed at an inlet of the compressor section 14. The IGVs 36 may control the amount of air that is conveyed into the compressor section 14. The IGVs 36 may be disposed at an angle that can be increased or decreased to allow less or more air into the compressor section.

In exemplary embodiments, the system 100 may further include a wash system 102 fluidly coupled to the gas turbine 10. For example, the wash system 102 may include a plurality of wash lines 104 extending each extending between the wash system 102 and a nozzle 106 disposed in the gas turbine 10. The wash lines 104 may each provide a cleaning fluid (such as water mixed with one or more agents or detergents) to a respective nozzle 106 for cleaning of the various gas turbine 10 components. For example, a first wash line 104 may extend between the wash system to a first nozzle 106 coupled to the compressor section 14 for selectively cleaning the compressor section components. A second wash line 104 may extend between the wash system 102 and a third nozzle 106 coupled to the turbine section 18 for selectively cleaning the turbine section components. Each of the wash lines 104 may be in fluid communication with a cleaning fluid supply tank. In some implementations, during offline water wash, the washing flow path (i.e., the flow path of the cleaning fluid) may include the combustion section 16.

In many embodiments, as shown, the wash system 102 may include a detergent selection system 108 and a detergent mixing system 110. The detergent selection system 108 may be operable to select a detergent or cleaning agent for mixing (e.g., in the mixing system 110) with water or other fluid to form the cleaning fluid that is used during the wash process.

The components of the gas turbine 10 may be washed with the wash system 102 either online or offline (e.g., online wash or offline wash). In an online wash, water (or a water mixed with detergent or cleaning agent) may be injected into the gas turbine 10 while the gas turbine 10 is running or operational. The online wash occurs while the gas turbine 10 maintains some form of output, albeit possibly less than a baseload (e.g., between about 5% and about 20% less than the baseload, or such as between about 10% and about 15% less than the baseload). The online wash may occur hourly, daily, monthly, quarterly, or at any other recurring time frame. Additionally, as described in more detail below, the online wash may occur based on one or more sensed particulate parameters. For example, the online wash may occur in response to determining, at least partially based on one or more sensed particulate parameters, that one of a particulate ingress level, fouling rate, a deposition rate, and a degradation rate associated with one or more components of the gas turbine has exceeded an online wash threshold, thereby prompting the wash system 102 to initiate the online wash.

An offline wash may involve a shutdown of the gas turbine 10 and subsequent cooling. Once the gas turbine 10 is cooled (particularly the turbine section 18), water (or a water mixed with detergent or cleaning agent) may be injected into the gas turbine 10, e.g., via the wash system 102. Shutting down the gas turbine 10 may enable a more thorough wash of the components, but the downtime of the gas turbine 10 may exceed downtime resulting from the online wash. For example, the turbine system 10 may remain shut down (or non-operational) from 8 to 24 hours depending on the thoroughness of the wash, the number of component receiving the wash, and a particular section of the gas turbine 10 that is washed. As such, an offline wash may occur less frequently than the online wash (e.g., quarterly, yearly, biennially, or at any other recurring time frame depending on the degradation rate of the gas turbine 10). Additionally, as described in more detail below, the offline wash may occur in response to determining, at least partially based on one or more sensed particulate parameters, that one of a particulate ingress level, a fouling rate, a deposition rate, and a degradation rate associated with one or more components of the gas turbine has exceeded an offline wash threshold, thereby prompting the gas turbine 10 to shut down and the wash system 102 to initiate an offline wash once the gas turbine 10 cools.

Fouling occurs when particulate enters the gas turbine compressor and alters the aerodynamic profile of the rotor blades and/or stator vanes via impact and frictional contact, which in turn reduces the compressor's overall efficiency. The level of particulate ingress into the gas turbine can increase the fouling rate of the components in the compressor. As discussed below, the controller, based on sensed data supplied to one or more models, may determine the fouling rate of the compressor, and may make one or more control actions based on the magnitude of the fouling rate. The degradation rate, or performance degradation, is determined by the reduction in power output of the gas turbine over time as a result of particulate ingress. For example, the more particulate ingress the gas turbine experiences, the more particulate builds up in the compressor/turbine section and/or causes fouling, thereby decreasing the efficiency of the gas turbine system over time. As discussed below, the controller, based on sensed data supplied to one or more models, may determine the degradation rate and may make one or more control actions based on the magnitude of the degradation rate. Particulate deposition occurs when particulate enters the compressor/turbine and gets stuck or couples to one or more compressor/turbine components, thereby impacting the aerodynamic profile of the components and reducing the efficiency of the engine. As discussed below, the controller, based on sensed data supplied to one or more models, may determine the particulate deposition rate in the compressor and/or the turbine and may make one or more control actions based on the magnitude of the deposition rate.

The inlet section 12 of the gas turbine 10 may include a filter house 120, which may include one or more filters for stopping large particles (such as large particles of sand, dust, dirt, etc.) from passing into the compressor section 14. The filter house 120 may include a plurality of vane filters 122 that may filter large particles from intake air 105 and an array of fabric filters 124 positioned downstream of the vane filters 122. The array of fabric filters 124 may be formed as any suitable filtering components and/or devices that may be configured to filter particles, e.g., finer/smaller particulates, from intake air flowing through the filter house 120.

The filter house 120 shown in FIG. 1 may include components, devices, and/or systems that may detect undesirable particles in intake air, that pass through or beyond the filters 122, 124 due to particle size, filter faults or deficiencies (from tears, holes, improper installation, and/or per recrystallization processes), filter manufacturing defects, and/or operational wear.

In many embodiments, the system 100 may include an electrostatic component 126 (such as a matrix of ionizers) positioned in the inlet section 12 (such as in the filter house 120). For example, the electrostatic component 126 may be positioned within the inlet section 12 downstream of the array of fabric filters 124. The electrostatic component 126 may be configured to charge particles passing therethrough, such that the particles hold an electrostatic charge, thereby making the particles easier to detect with sensing systems. The charged particles included in intake air may allow for easier and/or improved detection of particles before particles reach compressor section 14 of the gas turbine 10. In exemplary embodiments, the particle sensor(s) 112A, 112B, 112C, 112 D discussed hereinbelow may detect naturally charged particles without the presence of electrostatic component 126.

As shown in FIG. 1, in many embodiments, the system 100 may include particulate sensors 112A, 112B, 112C, 112D each in communication with a controller 200. The particulate sensors 112 may each be configured to sense data indicative of one or more particulate parameters and provide the data to the controller 200. The particulate parameters may be parameters associated with particulates entering/exiting the gas turbine from/to the atmosphere (or ambient environment). For example, in exemplary implementations of the system 100, the gas turbine 10 may be disposed in a desert environment. In such implementations, the particulate parameters may be associated with the sand particles entering/exiting the gas turbine 10. For example, the sensed particulate parameters may be the particulate type, size, weight, amount (e.g., volumetric amount of particulate per volumetric unit of air). In many embodiments, the particulate sensor(s) 112 may be configured to sense data indicative of particulate weight, particulate volume, particulate density, particulate type (e.g., sand, dust, etc.), particulate count, particulate amount, particulate size, and/or other data indicative of a particulate parameter.

The particulate sensors 112A, 112B, 112C, 112D are each operably coupled to and/or in operable (e.g., electronic) communication with the controller 200. The particulate sensors 112A, 112B, 112C, 112D may be positioned downstream of the filtration stages (e.g., the filters 122, 124). In certain embodiments, the particulate sensors 112A, 112B, 112C, 112D may be electrostatic and configured to detect the charged particles within the intake air that may be naturally charged or previously charged by the electrostatic component 126 and flow past the particulate sensors 112A, 112B, 112C, 112D. In some embodiments, each of the particulate sensors 112A, 112B, 112C, 112D may be formed as flush-mounted button sensors with high local resolution, multiple button system sensors arranged in a ring, circumferential ring sensors, and the like. Additionally, or alternatively, the particulate sensors 112A, 112B, 112C, 112D may be staged in flow direction to increase the detectability of charged particles dragged by the flow by correlating the signals of the different stages together with the flow speed known by the controller 200. It should be understood that the location(s) and number of the particulate sensors 112A, 112B, 112C, 112D shown in the embodiments may vary and the system 100 may include more or less than those shown in the figures.

During operation of gas turbine system 10, intake air 105 may flow through the filters 122, 124 to provide working fluid (e.g., filtered air 107) to compressor section 14. Some particles included in intake air 105 may flow through the filters 122, 124. The particles may be detected by the particulate sensors 112A, 112B, 112C, 112D. For example, the particulate sensors 112A, 112B, 112C, 112D may detect ingested particles and may provide information to the controller 200.

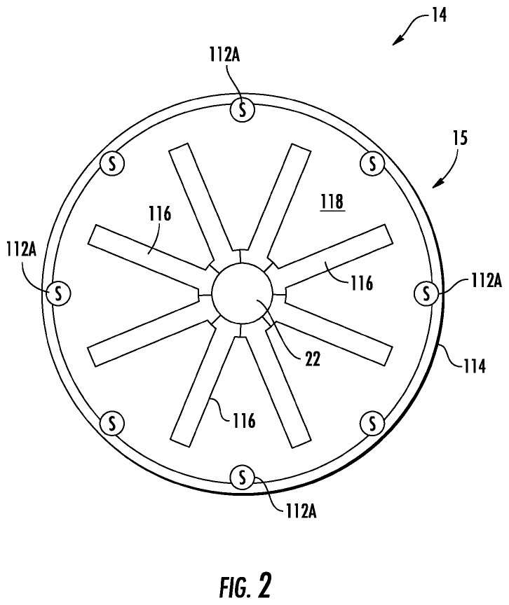

In exemplary embodiments, the particulate sensors 112A may be disposed in in the inlet of the gas turbine 10. For example, the particulate sensors 112A may be disposed at an inlet 15 of the compressor section 14 to measure data indicative of one or more particulate parameters entering the compressor section 14. Referring briefly to FIG. 2, a cross-sectional view of an inlet 15 to the compressor section 14 is provided in accordance with embodiments of the present disclosure. As shown, the compressor section 14 may include an outer casing 114, the shaft 22, and a plurality of rotor blades 116 extending radially between the shaft 22 and the outer casing 114. A compressor flowpath 118 may be defined between the outer casing 114 and the shaft 22 into which air from the filter house 120 flows. The particulate sensor 112A may be a plurality of particulate sensors 112A circumferentially spaced apart from one another (e.g., equally spaced) and disposed in the compressor section 14. For example, the plurality of particulate sensors 112A may be disposed on the outer casing 114 and within the flowpath 118, such that the particulate sensors 112 may measure data indicative of particulate parameters at an inlet 15 of the compressor section 14.

Referring back to FIG. 1, the system 100 may further include a particulate sensor 112B disposed at the outlet of the gas turbine 10. For example, the particulate sensor 112B may be disposed at an outlet 19 of the turbine section 18 to measure data indicative of one or more particulate parameters exiting the turbine section 18. In many embodiments (not shown), the particulate sensor 112B may be a plurality of particulate sensors 112B disposed in the outer casing of the turbine section 18 and circumferentially spaced apart from one another to measure data indicative of particulate parameters at an outlet 19 of the turbine section 18. In contrast to the particulate sensor 112A at the inlet 15 of the compressor section, which measures particulate parameters associated with particulate ingress (such as sand, dirt, dust, etc.), the particulate sensor 112B may measure particulate parameters associated with particulate egress (which includes the sand, dirt, dust, and also soot associated with incomplete consumption of fuel in the combustion section). In some implementations, if the sensor 112A does not measure particulate ingress to the compressor section 14 (e.g., no sand, dirt, dust, etc. is entering the gas turbine), but the sensor 112B measures particulate egress from the turbine section 18, then the controller 200 may determine that incomplete consumption of fuel is taking place in the combustion section 16 resulting in soot exiting the turbine section 18 (and potentially building up in the turbine section 18 impacting efficiency). As a response, the controller 200 may adjust an amount of fuel (e.g., increase or decrease the fuel from the fuel supply) or change the fuel type (e.g., gaseous or liquid) in order to reduce soot production and form more complete combustion in the combustion section.

Additionally, in many embodiments, the system 100 may further include one or more particulate sensors 112C disposed in the inlet section 12, such as in the filter house, to measure data indicative of particulate parameters in the inlet section 12. Furthermore, in various embodiments, the system 100 may further include one or more particulate sensors 112D disposed in the exhaust section, such as in an exhaust stack, to measure data indicative of particulate parameters in the exhaust section 20.

Additionally, in many embodiments, the system 100 may include a compressor sensor 136, a combustor sensor 138, and a turbine sensor 140 each in operable communication with the controller 200. The compressor sensor 136 may be disposed in the compressor section 14 and may be configured to measure data indicative of one or more parameters associated with the compressor section 14. For example, the compressor sensor 136 may be configured to measure and provide data indicative of a pressure, a temperature, an air flow speed, compressor rotating speed, or other data associated with the compressor section 14. The combustor sensor 138 may be disposed in the combustion section 16 and configured to measure and provide data associated with the combustion section 16. For example, the combustor sensor 138 may be configured to provide data indicative of a pressure, a temperature, a flow speed of combustion gases, a composition of combustion gases, a fuel type, or other data associated with the combustion section 16. The turbine sensor 140 may be disposed in the turbine section 18 and may be configured to measure data indicative of one or more parameters associated with the turbine section 18. For example, the turbine sensor 140 may be configured to measure and provide data indicative of a pressure, a temperature, a combustion gas flow speed, a turbine rotating speed, or other data associated with the turbine section 18. Additionally, the controller may utilize any of the sensed data from the compressor sensor 136, the combustor sensor 138, and the turbine sensor 140 along with the data indicative of one or more particulate parameters from the particulate sensors 112A, 112B, 112C, 112D to determine a fouling rate, a deposition rate, and a degradation rate associated with one or more components of the gas turbine 10.

In certain embodiments, the system 100 may include one or more filter house sensors 142 each in operable communication with the controller 200. The filter house sensors 142 may be disposed on opposite sides of the array of fabric filters 124. In such embodiments, the filter house sensors 142 may each be configured to sense and provide data indicative of a pressure to the controller 200. The controller 200 can compare the data indicative of a pressure from each filter house sensor 142 to determine a pressure difference across the array of fabric filters 124. The controller 200 may monitor the pressure difference across the array of fabric filters 124 to determine the health and remaining life of the fabric filters 124. Additionally, the pressure difference across the fabric filters 124 may be utilized by the controller 200 along with the data indicative of one or more particulate parameters from the particulate sensors 112A, 112B, 112C, 112D to determine a fouling rate, a deposition rate, and a degradation rate associated with one or more components of the gas turbine 10.

In various embodiments, the system 100 may further include an environmental sensor 128 disposed outside of the gas turbine 10. the environmental sensor 128 may be communicatively coupled to the controller 200 and configured to provide data indicative of harsh weather conditions. The data indicative of harsh weather conditions may include ambient temperature, ambient pressure, specific and relative humidity, and/or wind speed. Additionally, the data indicative of harsh weather conditions may include parameters associated with particulate in the ambient environment surrounding the gas turbine 10, such as amount of particulate in the air (which may increase/decrease with weather conditions), type of particulate in the air (e.g., sand, dust, dirt, etc.), size of particulate in the air, and other parameters. The controller 200 may implement a control action associated with the wash system 102 based on the data indicative of harsh weather conditions from the environmental sensor 128.

In exemplary embodiments, the gas turbine 10 may further include an extraction cooling pipe 130 extending between the compressor section 14 and the turbine section 18. For example, the extraction cooling pipe 130 may extend from an inlet disposed on, and in fluid communication with, the outer casing of the compressor section 14 to an outlet disposed on, and in fluid communication with, one or more components in the turbine section 18 (such as the turbine rotor blades and/or the turbine stator vanes). The extraction cooling pipe 130 may be configured to convey bleed air from the compressor section 14 to the turbine section 18 for use in one or more turbine components (e.g., for cooling the one or more turbine components). A contamination sensor 132 may be disposed in the extraction cooling pipe 130. The contamination sensor 132 may be in communication with the controller 200 and configured to provide data indicative of particulate contamination in the bleed air to the controller. The data indicative of particulate contamination in the bleed air may include an amount of particulate in the bleed air, a size of particulate in the bleed air, a type of particulate in the bleed air (e.g., sand, dust, dirt, etc.), and other particulate parameters. The controller 200 may implement a control action associated with the wash system 102 based on the data indicative of particulate contamination in the bleed air.

In many embodiments, the system 100 may include a fuel supply system 134 configured to supply fuel to the combustion section 16. For example, the fuel supply system 134 may include a fuel supply 137 and one or more fuel lines extending between the fuel supply 137 and the combustion section 16. The fuel supply system may be configured to supply gaseous fuel and/or liquid fuel to the combustion section 16.

In many embodiments, the controller 200 may include one or more models 202 (e.g., stored in the memory and executable by the processors), and the controller 200 may provide the data indicative of one or more particulate parameters from the particulate sensor(s) 112 to the one or more models 202. Additionally, the controller 200 may provide data from the compressor sensor 136, the combustor sensor 138, and/or the turbine sensor 140. In some embodiments, the model 202 may be built by the controller 200 (or may be stored in the memory of the controller 200). The model 202 may assess measured data indicative of one or more particulate parameters provided by the particulate sensor(s) 112 (as well as other sensors in the system 100) to determine a fouling rate, a deposition rate, and a degradation rate associated with one or more components of the gas turbine.

In some embodiments, the sensor data may be provided to a data management system 204, such as an inlet monitoring system or an outlet monitoring system. The data management system 204 may be stored in the memory of the controller 200 and executable by a processor of the controller 200. Alternatively, the data management system 204 may be a standalone computing system. The data management system 204 may filter noise from the sensor data and to reduce error. The data management system 204 may receive the data indicative of one or more particulate parameters (as well as data from other sensors in the system 100) as an input and may provide the velocity, average size, volume, type, distribution and/or dispersion pattern of the particulates entering/exiting the gas turbine 10 as an output to the one or more models 202. In some embodiments, the inlet monitoring system and the outlet monitoring system may be models stored in the memory of the controller 200 (and/or executable by the processor). In other embodiments the inlet monitoring system and the outlet monitoring system may be standalone computing systems that receive the data indicative of one or more particulate parameters as an input and may provide the velocity, average size, volume, type, distribution and/or dispersion pattern of the particulates entering/exiting the gas turbine 10 as an output.

The one or more models 202 may include a set of equations and algorithms, that allow the controller 200 to analyze the measured data, in order to determine deposition rates, fouling rates, and/or degradation rates.

In one embodiment, the model 202 may determine a total contaminant level (“TCL” in parts per million by weight, hereafter “ppmw”) according to the following equation:

TCL=I_{f}+[Iₐᵢᵣ×A/F]+[I×W/F]+[Iₛₜₘ×S/F]

where I_{f} is the contaminant level in the fuel (ppmw), Iₐᵢᵣ is the contaminant level in the air (ppmw), I_{w} is the contaminant level in the injection water (ppmw), Iₛₜₘ is the contaminant level in the injection steam (ppmw), A/F is the air to fuel ratio for the gas turbine, S/F is the steam to fuel ratio, and W/F is the water to fuel ratio. The particulate behavior is captured by the Stokes number St, where:

$$St = \frac{{ρ}_{p} {d}_{p}^{2} U}{18 μ \cdot 2 L}$$

$$L = s sin ( {β}_{b} - {β}_{1} )$$

Larger particles, with a larger Stokes number St, will show greater deviations from the gas flow path, and will therefore impact more frequently on the pressure side of the blade. As a result, the capture rate E, increases with the Stokes number St according to:

E=0.08855·St−0.0055

The diffusion of particles in laminar flow within a tube of radius R, can be described by:

$$n / {n}_{o} = 1 - 2.56 \cdot {( \frac{Dx}{{R}^{2} U} )}^{\frac{2}{3}} + 1.2 \cdot ( \frac{Dx}{{R}^{2} U} ) + 0.0177 {( \frac{Dx}{{R}^{2} U} )}^{4 / 3}$$

where n is the number of particles out of an initial n₀ particles that is not captured by the tube walls after traveling a distance x along the tube and D is the diffusion coefficient, which depends on the particle size and flow velocity, among other things. Similar equations describe the diffusion for flows in channels with parallel walls.

In some embodiments, air flow in a tube indicating that the particle flux I (i.e., the flow of particles per surface area and time) to the tube walls is described by:

$$\frac{I}{{N}_{0}} = \frac{{D}^{\frac{3}{4}} {Re}_{f}^{\frac{7}{8}} {v}^{\frac{1}{4}}}{90 \cdot {r}_{particle}} = \frac{{D}^{\frac{3}{4}} {U}_{f}^{\frac{7}{8}} {v}^{- \frac{5}{8}}}{90 \cdot ( {r}_{particle} / {L}^{\frac{7}{8}} )}$$

for a constant amount No of particles in the air, increasing flow velocity and reducing relative particle size both lead to increased deposition rates. This means, in particular, that the larger the blade dimension L for a given particle size, the higher the deposition rate. Therefore, a larger compressor has a higher particle accumulation for a given particle size distribution than a smaller compressor. The performance of a compressor stage with increased surface roughness, when compared to a smooth stage, encounters significant deterioration (with a surface roughness equivalent to about:

kₛ/c=0.714×10⁻³ (kₛ=40 μm).

The degradation is determined mainly by the roughness on the suction side. For a typical compressor blade in an industrial gas turbine with a 100 mm chord length, this is equivalent to a surface roughness of 71 μm.

A relationship for fouling exists that combines the geometric and aero-thermal characteristics of the compressor section 14. It is derived based on considerations of the entrainment efficiency of a cylinder due to inertial deposition corrected to the entrainment efficiency of a row of airfoils due to inertial deposition:

$$ISF = \frac{{Wc}_{p} Δ {T}_{stage}}{( 1 - {r}_{h}^{2} ) {D}_{c}^{3}} \cdot {10}^{- 6} .$$

The susceptibility of a given engine to particles of a certain size is:

$$λ = ISF \cdot \frac{{ρ}_{p} \cdot {d}_{p}^{2}}{{η}_{f}} .$$

Larger, heavier particles have a higher chance than small particles to collide with the blade surface and the model predicts a higher susceptibility of smaller gas turbines to fouling, with some impact of higher stage loading. Fouling is closely related to the geometric and flow characteristics of the axial compressor stage. Adhesion of particles to blades (defined as the cascade collection efficiency) is increased with a decrease of chord length and an increase of solidity. Furthermore, fouling is increased with reduced flow rates, which are closely related to the incoming air velocities. Large particles increase the cascade collection efficiency. Deposition of large particles in front stages makes fouling dominant in front stages, but small particles pass through the front stages and influence downstream compressor stages. Particle size distribution is an important parameter that influences the extent of the fouling.

The collection efficiency is inversely affected by particle size and flow velocity, i.e., the smaller the particle and the slower the airflow, the higher the deposition rate becomes. For an airfoil of chord length L, the collection efficiency for the diffusion process becomes:

$$λ = 3 \frac{{( \frac{8 hDR}{3 \overline{U}} )}^{2 / 3}}{2 {h}^{2}} = 2.884 \frac{{( \frac{DR}{\overline{U}} )}^{2 / 3}}{{h}^{4 / 3}}$$

with Ū being the free stream flow velocity, D being the diffusion coefficient, R being the maximum thickness of the blade, and h being the blade-to-blade distance. Wider spaced blades and higher flow velocity both lower collection efficiency. It must be determined which factors affect the diffusion coefficient D. If the majority of diffusion is turbulent diffusion (which is orders of magnitude larger than laminar diffusion and is driven by turbulent eddies) it can be assumed that the diffusion rate is determined by the turbulence rate in the flow. The fouling index FI is expressed by:

$$FI = \frac{{P}_{GT}}{{Wc}_{p} Δ T} \approx \frac{{P}_{GT}}{{P}_{compr}} .$$

A wide range of gas turbines has been studied to evaluate their sensitivity to an imposed level of fouling. The results indicate that the net work ratio (NWR/Wₜ) is indicative of both the gas turbine's susceptibility to foul and its sensitivity to the effects of fouling. Low net work ratio engines where a higher portion of the total turbine work is represented by:

$$\frac{W {′}_{out}}{{W}_{out}} = \frac{{W}_{t} - W {′}_{c}}{{W}_{t} - {W}_{c}} = \frac{{W}_{t} - \frac{{η′}_{c}}{{η}_{c}} W {′}_{c}}{{W}_{t} - {W}_{c}} = \frac{\frac{{W}_{out}}{NWR} - \frac{{η}_{c}}{{η′}_{c}} {W}_{out} ( \frac{1}{NWR} - 1 )}{{W}_{out}} = \frac{1}{NWR} - \frac{{η}_{c}}{{η′}_{c}} ( \frac{1}{NWR} - 1 ) .$$

The model 202 utilizes the data indicative of one or more particulate parameters from the particulate sensors(s) 112 and/or the data management system 204 to determine the fouling rate, the deposition rate, and the degradation rate associated with one or more components of the gas turbine. Additionally, or alternatively, model 202 utilizes the data indicative of one or more particulate parameters from the particulate sensors(s) 112 and/or the data management system 204 to determine the total accumulated dirt-load, estimate dirt-load over time, and/or the filtration efficiency. Furthermore, the model 202 may forecast degradation rates, fouling rates, and/or deposition rates. In response to the forecast, the controller 200 may adjust or alter a wash schedule to minimize down time of the gas turbine 10. The determined total accumulated dirt load allows the model 202 to establish a remaining lifetime of the gas turbine 10 versus the fired hours and the dirt-load. If the estimated dirt-load over time is too high (e.g., above a predetermined threshold), the model 202 may recommend and/or command an online wash, until the conditions have passed or increase the pulsing frequency of the wash to remove more sand/dirt from the components, etc.

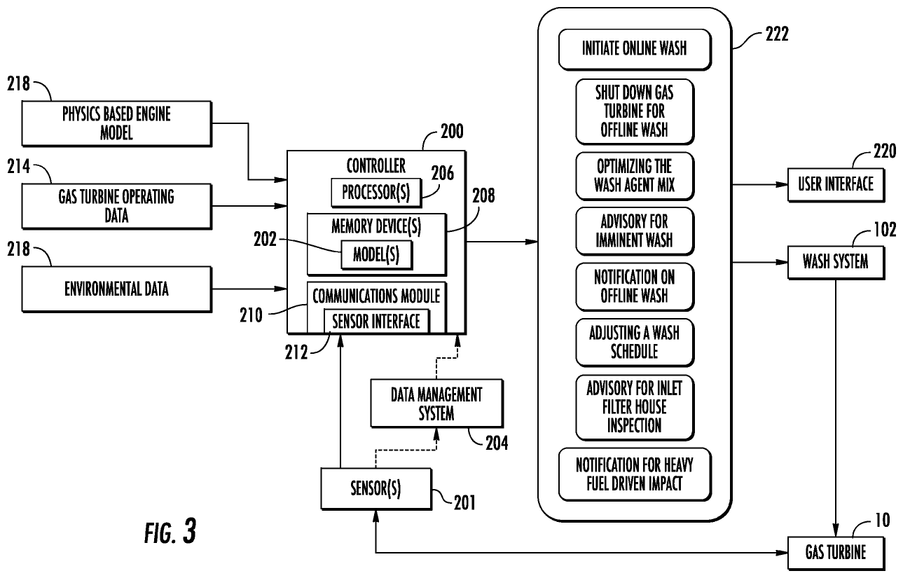

Referring now to FIG. 3, a block diagram of the system 100 is illustrated in accordance with embodiments of the present disclosure. As shown, the system 100 includes a controller 200 and one or more sensor(s) 201 in operable communication with the controller 200 and configured to monitor one or more operating parameters of the gas turbine 10. The sensor(s) 201 may include any of the sensors described above with reference to FIG. 1, such as the particulate sensors 112A, 112B, 112C, 112D, the compressor sensor 136, the combustor sensor 138, the turbine sensor 140, the filter house sensors 142, or others.

Still referring to FIG. 3, the controller 200 is shown as a block diagram to illustrate the suitable components that may be included within the controller 200. As shown, the controller 200 may include one or more processor(s) 206 and associated memory device(s) 208 (or memory) configured to perform a variety of computer-implemented functions (e.g., performing the methods, steps, calculations and the like and storing relevant data as disclosed herein). Additionally, the controller 200 may also include a communications module 210 to facilitate communications between the controller 200 and the various components of the system 100. For example, the communications module 210 may be in communication with the gas turbine 10 and the wash system 102, in order to allow the processor 206 to selectively initiate an online wash or shut down the gas turbine 10 for an offline wash. Further, the communications module may include a sensor interface 212 (e.g., one or more analog-to-digital converters) to permit signals transmitted from one or more sensor 201 to be converted into signals that can be understood and processed by the processors 206. It should be appreciated that the sensor(s) 201 may be communicatively coupled to the communications module 210 using any suitable means. For example, the sensor(s) 201 may be coupled to the sensor interface 212 via a wired connection. However, in other embodiments, the sensor(s) 201 may be coupled to the sensor interface 212 via a wireless connection, such as by using any suitable wireless communications protocol known in the art. Additionally, or alternatively, one or more of the sensor(s) 201 may be communicably coupled to the data management system 204, which may in turn be coupled to the controller 200.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 208 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 208 may generally be configured to store suitable computer-readable instructions that, when implemented by the processor(s) 206, configure the controller 200 to perform various functions and/or operations including, but not limited to, providing data indicative of one or more particulate parameters from a particulate sensor to one or more models 202 (which may be stored in the memory devices 208); determining, with the one or more models 202, at least one of a fouling rate, a deposition rate, and a degradation rate associated with one or more components of the gas turbine 10 based on the one or more particulate parameters; and, implementing a control action associated with a wash system 102 based on a magnitude of at least one of the fouling rate, the deposition rate, and the degradation rate.

Additionally, as shown in FIG. 2, the controller 200 may receive gas turbine operating data 214 and environmental data 216 as an additional input. The gas turbine operating data 214 and environmental data 216 may be utilized by the one or more model(s) to determine the fouling rate, the deposition rate, and the degradation rate associated with one or more components of the gas turbine 10. The environmental data may include wind speed at the location of the gas turbine, a dust or sandstorm index, a concentration of particulate (such as sand, dust, dirt, etc.) in the ambient air, an ambient temperature, and/or an ambient pressure. The gas turbine operating data 214 may include IGV angles, compressor inlet temperature, compressor airflow speed, compressor efficiency, compressor discharge parameters, temperature and/or pressure of combustion gases, and other turbine operating data. The environmental data 216 and the gas turbine operating data 214 may be provided to the controller 200 in real time.

In many embodiments, the controller 200 may utilize a physics-based engine model 218 of the gas turbine 10 (such as a “digital twin” model). The physics-based engine model 218 may virtually represent the state of the gas turbine 10. The physics-based engine model 218 may include parameters and dimensions of its physical twin's parameters and dimensions that provide measured values and keeps the values of those parameters and dimensions current by receiving and updating values via outputs from sensors embedded in the physical twin. The digital twin may have respective virtual components that correspond to essentially all physical and operational components of the gas turbine 10.

The physics-based engine model 218 may be stored within the memory 208 of the controller 200 and may be executable by the processor 206. In general, the physics-based engine model 218 may be provided with one or more inputs, and at least partially based on the one or more inputs, the engine digital twin model may generate one or more outputs. For example, the physics-based engine model 218 may operate in tandem (i.e., alongside or together) with the one or more models 202, such that the physics-based engine model 218 may provide the one or more models 202 with the gas turbine operating data 214. The physics-based engine model 218 may be used for validating or verifying the sensed data from the one or more sensors 201.

As shown in FIG. 3, based on the data received from the one or more sensors 201, the environmental data 216, the gas turbine operating data 214, and/or data from the physics-based engine model 218, the controller 200 may determine the level of particulate ingress, the fouling rate, the deposition rate, and the degradation rate associated with the particulate ingress of the gas turbine 10. Based on the magnitude of the particulate ingress, the fouling rate, the deposition rate, and the degradation rate associated with the particulate ingress of the gas turbine 10, the controller 200 may initiate one or more control actions 222 associated with the wash system 102 and/or the gas turbine 10. For example, the one or more control actions 222 may include initiating an online wash of the gas turbine 10 with the wash system 102, shutting down the gas turbine 10 for an offline wash, and/or optimizing the wash agent (or detergent) mixture. Optimizing the wash agent (or detergent) mixture may include adjusting the amount (or a concentration) of the agent (or detergent) mixed with the water based on the intensity of the wash that is necessary. For example, if the magnitude of at least one of the fouling rate, the deposition rate, and the degradation rate is high, then the amount (or concentration) of detergent in the cleaning fluid may be increased.

The controller 200 may also be configured to generate a notification signal when the controller 200 determines that a magnitude of at least one of the fouling rate, the deposition rate, and the degradation rate has exceeded one or more thresholds. Thus, as shown in FIG. 3, as an example, the controller 200 may be configured to send the notification signal to a user, e.g., via a user interface 220. The notification signal may be associated with the wash system 102, such as an advisory for an imminent wash (i.e., a notification for an upcoming wash based on the fouling rate, deposition rate, and/or degradation rate) or a notification on an offline wash (i.e., that the gas turbine 10 will be shutting down for an offline wash). The notification may also be associated with the gas turbine 10, such as an advisory for a filter house 120 inspection or a notification for heavy fuel driven impact (i.e., the fuel efficiency is impacted as a result of the particulate ingress).

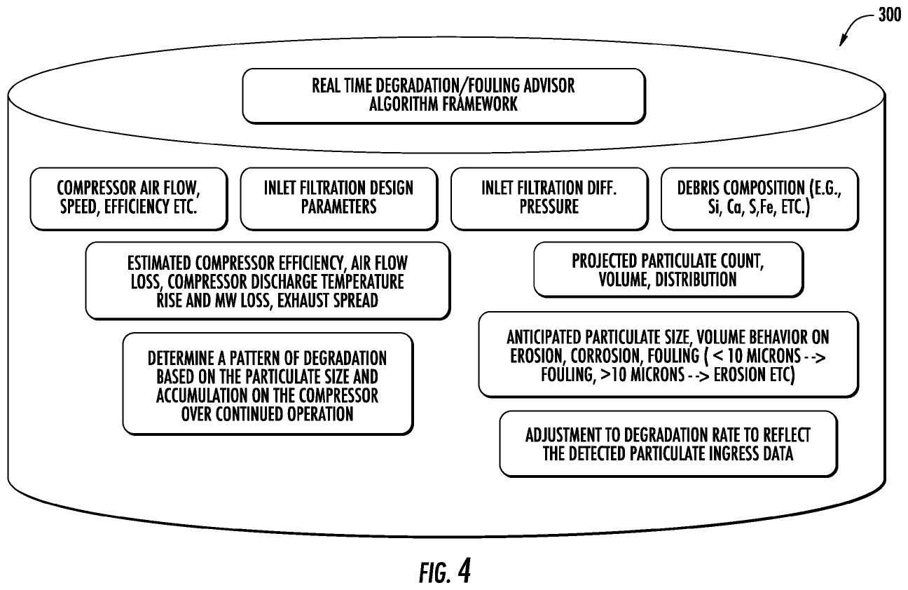

Referring now to FIG. 4, a real time degradation/fouling advisor algorithm framework 300 is provided, in accordance with an exemplary aspect of the present disclosure. The real time degradation/fouling advisor algorithm framework 300 may be stored in the memory devices 208 and executable by the processors 206. The real time degradation/fouling advisor algorithm framework 300 may form a portion of the models 202, may be utilized by the models 202, and/or may be consulted by the controller 200. The models 202 may utilize the real time degradation/fouling advisor algorithm framework 300 to analyze the sensed data and evaluate data related to the compressor section 14 (e.g., compressor air flow speed, compressor efficiency, etc.), inlet filtration design parameters, filtration efficiency, inlet filtration differential pressure (“DP”), operating hours, debris monitoring, and/or debris composition (e.g., Si, Ca, S, Fe, etc.). Using the real time degradation/fouling advisor algorithm framework 300, the model 202 may compare the real compressor efficiency with the expected (or estimated compressor efficiency) in order to determine the air flow loss, the compressor performance drop and power loss (or MW loss), and the exhaust spread.

Further, using the real time degradation/fouling advisor algorithm framework 300, the model 202 may determine a pattern of degradation based on the particulate size and accumulation on the compressor over continued operation. For example, the pattern of degradation on the compressor may include periods of high degradation on the compressor and periods of low degradation on the compressor. The controller 200 may initiate an online wash of the compressor section 14 during the periods of high degradation on the compressor. Additionally, using the real time degradation/fouling advisor algorithm framework 300, the model 202 may determine the projected particulate count, volume, and/or dispersion for particulate entering the gas turbine 10. Similarly, the model 202 may determine the anticipate particulate size and volume behavior (or impact) on erosion, corrosion, and/or fouling in the compressor section 14 and/or the turbine section 18. For example, if the anticipated particulate size/volume is less than 10 microns, then the model 202 may determine that the compressor section 14 and/or the turbine section 18 is experiencing increased fouling. Further, if the anticipated particulate size/volume is greater than 10 microns then the model 202 may determine that the compressor section 14 and/or the turbine section 18 is experiencing increased erosion. As such, the controller 200 may initiate one or more control actions associated with the wash system (such as the online wash timing, the offline wash schedule, etc.) in response to determining the anticipated particulate size/volume to account for the fouling/erosion. Additionally, the controller 200 may adjust the degradation rate to reflect the detected ingress data and based on the adjustment to the degradation rate (i.e., the new magnitude of the degradation rate), the controller 200 may adjust the wash schedule for the gas turbine 10, may initiate an online wash, or may shut down the gas turbine for an offline wash.

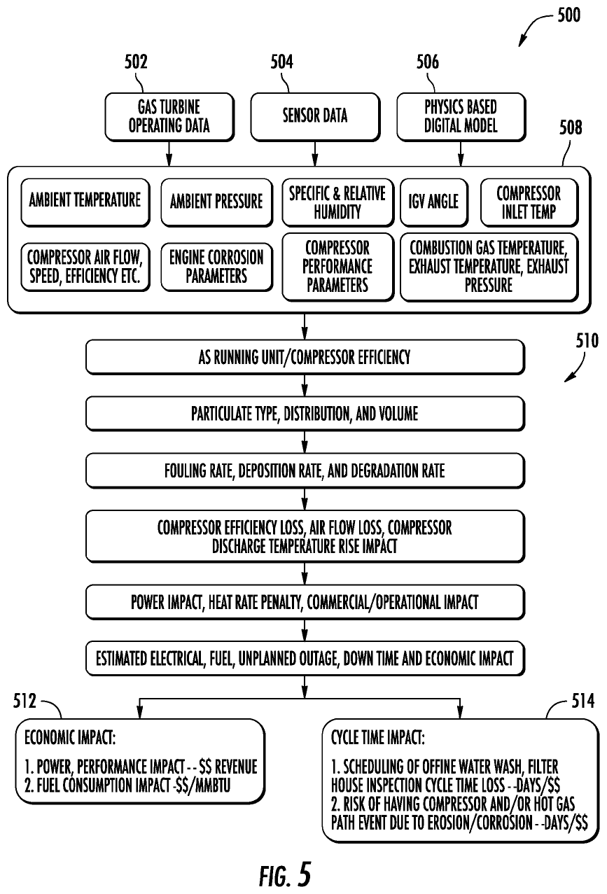

Referring now to FIG. 5, a flow chart of model 500 (such as the model 202 described above or a different model), which may be utilized by the controller 200, for monitoring and responding to particulate ingress in the gas turbine 10 is provided. The model 500 may be supplied with inputs 508, and may process the inputs 508 with one or more algorithms, set of equations, lookup tables, graphs, to determine outputs 510. Based on the outputs 510, the controller 200 may implement one or more control actions associated with the wash system 102. The inputs 508 to the model 500 may include gas turbine operating data 502, sensor data 504 (e.g., from one or more of the sensors described above with reference to FIG. 1), and/or data from the physics based engine model 506. The inputs 508 may include ambient temperature, ambient pressure, specific and relative humidity, inlet guide vane angle, compressor inlet temperature, compressor airflow speed, compressor efficiency, engine corrosion parameters, compressor performance changes, combustion gas temperature, exhaust temperature, and/or exhaust pressure.

The outputs 510 of the model 500 may be calculated in order, such that each output 510 is calculated using the information from prior calculated output. The outputs 510 from the model 500 may include the as running compressor efficiency (e.g., the real time compressor efficiency), the particulate type (e.g., sand, dust, dirt, etc.), distribution, and volume. The outputs 510 from the model 500 may further include the fouling rate, the deposition rate, and the degradation rate. The model 500 may further determine the compressor efficiency loss (e.g., resulting from the sensed particulate ingress), and the air flow loss, and the compressor performance drop impact. Once the compressor efficiency loss, air flow loss, and compressor performance drop are calculated by the controller 200 using the model 500, the controller 200 may further determine the power impact (e.g., the MW impact), the heat rate penalty, and the operation and maintenance impact. Lastly, the model 500 may determine the estimated electrical impact on the gas turbine as a result of the particulate ingress and/or the estimated fuel impact on the gas turbine as a result of the particulate ingress. Additionally, the model 500 may determine whether or not an unplanned outage is necessary, the down time associated with such unplanned outage, and the economic impact associated with such unplanned outage.

As illustrated in FIG. 5, in some embodiments, the model 500 may provide the economic impact 512 as a result of the particulate ingress, which may include loss in revenue due to power and/or performance impact, loss in revenue due to inefficient fuel consumption, etc. The model 500 may further provide the cycle time impact 514 associated with the maintenance actions necessary to mitigate impact on the gas turbine 10 due to the particulate ingress, such as the down time associated with an offline wash (in dollars per day), the down time associated with a filter house inspection (in dollars per day), or the down time associated with other maintenance actions. Further, the cycle time impact 514 may include an estimation of down time associated with an erosion/corrosion risk parameter that is generated based on the amount of particulate ingress, the deposition rate, the degradation rate, and the fouling rate. If the risk parameter exceeds a risk threshold, then the controller 200 may initiate an online wash, adjust one or more gas turbine operating parameters, adjust a detergent mixture in the cleaning fluid, and/or shut down the gas turbine for an offline wash.

Based on the outputs 510, the economic impact 512, and/or the cycle time impact 514, the controller 200 may initiate one or more control actions to mitigate down time of the gas turbine 10. For example, if high particulate ingress is detected and/or the environmental data indicates high amounts of dust, dirt, sand, or other particulates, then the controller 200 may schedule and/or initiate an online wash of the gas turbine 10 with the wash system 102. Additionally, the controller may generate a notification (which may be provided to the user interface 220) that an online wash is imminent.

If the outputs 510 of the model 500 indicate that the gas turbine 10 is experiencing high particulate ingress (e.g., greater than a first threshold), particulate deposit accumulation, and/or that the wash system 102 is being repetitively used for online washes (due to high particulate ingress), then the controller 200 may generate an alarm or notification (which may be provided to the user interface 220) that a filter house 120 inspection is necessary. For example, the controller 200 may predict that the high particulate ingress is due to a filter house breach (i.e., one or more of the filters has ripped or broken such that the filter is no longer active), and the controller 200 may provide a notification that the filter house 120 may be breached. Additionally, or alternatively, if the model 500 indicates that the gas turbine 10 is experiencing very high particulate ingress (e.g., greater than a second threshold—the second threshold greater than the first threshold) and/or particulate deposit accumulation, then the controller 200 may generate a recommendation on a timing for shut down of the gas turbine 10. The recommendation on timing for shut down of the gas turbine 10 may minimize the economic impact and/or the cycle time impact as a result of the offline wash (e.g., the shut down time may be during a low power load period). In some embodiments, the controller 200 may determine the type of detergents and/or optimal mixture of for the cleaning fluid to be used in the offline wash based on the magnitude of the fouling rate, deposition rate, degradation rate, and/or other parameters associated with the particulate ingress of the gas turbine 10.

In operation, by continually monitoring the particulate ingress of the gas turbine 10 and the fouling rate, the deposition rate, and the degradation rate of the gas turbine as a result of the particulate ingress, the controller 200 may minimize the number of necessary offline washes (thereby minimizing downtime) by timely addressing the particulate ingress with an online wash.

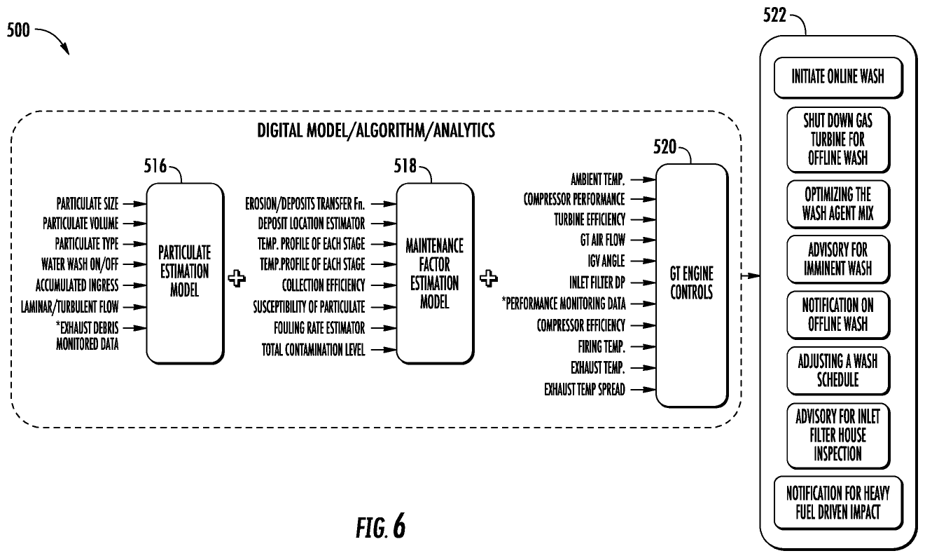

Referring now to FIG. 6, a block diagram of one or more aspects of the model 500 for monitoring and responding to particulate ingress in the gas turbine 10 is illustrated in accordance with embodiments of the present disclosure. As shown, the model 500 may include a particulate estimation model 516, a maintenance factor estimation model 518, and gas turbine engine controls 520. The particulate estimation model 516, the maintenance factor estimation model 518, and the gas turbine engine controls 520 may operate together to produce one or more control actions 522 based on the particulate ingress of the gas turbine 10. The particulate estimation model 516 may be supplied with one or more inputs (e.g., from the one or more sensors described above with reference to FIG. 1), including but not limited to, particulate size, particulate volume, particulate type, whether the wash system 102 is on or off, the accumulated ingress, and exhaust debris monitored data. The maintenance factor estimation model 518 may be supplied with one or more inputs, including but not limited to, an erosion/deposits transfer function, a deposit location estimator, a temperature profile of each stage (e.g., of compressor blades or turbine blades), a collection efficiency, a susceptibility of particulate, a fouling rate estimator, and/or a total contamination level. The gas turbine engine controls 520 may include and/or be supplied with one or more inputs, including but not limited to ambient temperature, compressor discharge parameters, turbine efficiency, gas turbine air flow, IGV angle, inlet filter pressure differential, performance monitoring data, compressor efficiency, firing temperature, exhaust temperature, and/or exhaust temperature spread.

In many embodiments, the controller 200 may initiate one or more control actions 522 associated with the wash system 102 and/or the gas turbine 10 based on the calculations of the model 500. For example, the one or more control actions 522 may include initiating an online wash of the gas turbine 10 with the wash system 102, shutting down the gas turbine 10 for an offline wash, and/or optimizing the wash agent (or detergent) mixture. Optimizing the wash agent (or detergent) mixture may include adjusting the amount (or a concentration) of the agent (or detergent) mixed with the water based on the intensity of the wash that is necessary. For example, if the magnitude of at least one of the fouling rate, the deposition rate, and the degradation rate is high, then the amount (or concentration) of detergent in the cleaning fluid may be increased.

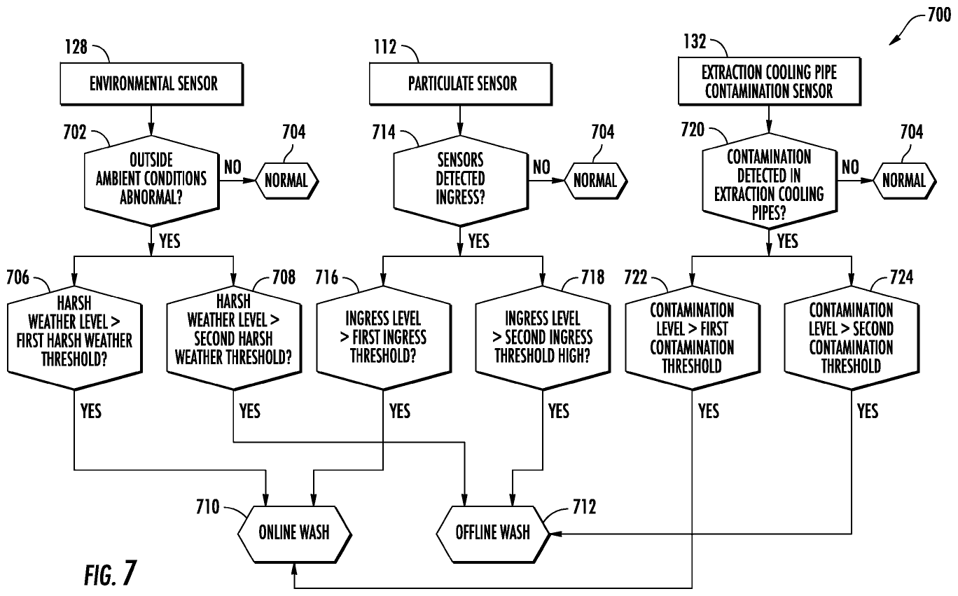

Referring now to FIG. 7, a logic flow chart 700 is illustrated in accordance with one or more exemplary aspects of the present disclosure. The logic flow chart 700 may be followed by the controller 200 in determining when to perform an online wash, an offline wash, or continue normal operation of the gas turbine 10. As shown, the logic flow chart 700 may consider data from the environmental sensor 128, the particulate sensor 112 (such as the particulate sensors 112A, 112B, 112C, 112D), and the contamination sensor 132 in the extraction cooling pipe 130.

In decision block 702, the controller may determine whether or not the data from the environmental sensor 128 is indicative of abnormal ambient conditions (e.g., whether or not the wind speed, ambient temperature, ambient pressure, humidity, etc. is abnormally high/low based on historical data or other considerations). If not, then the gas turbine 10 may continue normal operations as shown by block 704. If outside ambient conditions are abnormal, as shown in blocks 706 and 708, then the controller 200 may determine whether or not the data indicative of harsh weather conditions is greater than a first harsh weather threshold and/or a second harsh weather threshold. The second harsh weather threshold may be greater than the first harsh weather threshold. The harsh weather thresholds may include thresholds for one or more weather related parameters, such as wind speed, ambient temperature, ambient pressure, humidity, amount of particulate in the ambient environment, size of particulate in the ambient environment, or other weather-related parameters. If the data indicative of harsh weather conditions is greater than the first harsh weather threshold (but not the second harsh weather threshold), then the controller 200 may send a signal to the wash system 102 to initiate an online wash (as shown by block 710). If the data indicative of harsh weather conditions is greater than the second harsh weather threshold, then the controller 200 may shut down the gas turbine 10 for an offline wash (as shown by block 712).

In decision block 714, the controller may determine whether or not the data from the particulate sensor 112 is indicative particulate ingress in the gas turbine (or particulate egress from the gas turbine in some instances). If not, then the gas turbine 10 may continue normal operations as shown by block 704. If particulate ingress is detected (or particulate egress in some instances), as shown in blocks 716 and 718, then the controller 200 may determine whether or not the particulate ingress level is greater than a first ingress threshold and/or a second ingress threshold. The second ingress threshold may be greater than the first ingress threshold. If the data indicative of particulate ingress is greater than the first ingress threshold (but not the second ingress threshold), then the controller 200 may send a signal to the wash system 102 to initiate an online wash (as shown by block 710). If the data indicative of particulate ingress is greater than the second ingress threshold, then the controller 200 may shut down the gas turbine 10 for an offline wash (as shown by block 712).

In decision block 720, the controller may determine whether or not the data from the contamination sensor 132 is indicative of particulate contamination in the bleed air conveying through the extraction cooling pipe 130. If not, then the gas turbine 10 may continue normal operations as shown by block 704. If particulate contamination is detected in the bleed air, as shown in blocks 722 and 724, then the controller 200 may determine whether or not the particulate contamination level is greater than a first contamination threshold and/or a second contamination threshold. The second contamination threshold may be greater than the first contamination threshold. If the data indicative of particulate contamination is greater than the first contamination threshold (but not the second contamination threshold), then the controller 200 may send a signal to the wash system 102 to initiate an online wash (as shown by block 710). If the data indicative of particulate contamination is greater than the second contamination threshold, then the controller 200 may shut down the gas turbine 10 for an offline wash (as shown by block 712).

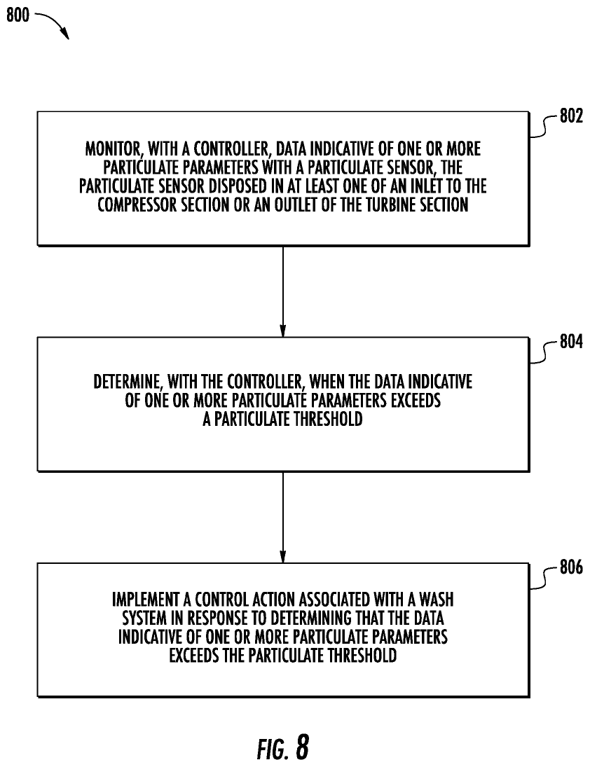

Referring now to FIG. 8, a flow diagram of one embodiment of a method 800 for timely addressing particulates in a gas turbine is illustrated in accordance with aspects of the present subject matter. In general, the method 800 will be described herein with reference to the gas turbine 10 and the system 100 described above with reference to FIGS. 1 through 7. However, it will be appreciated by those of ordinary skill in the art that the disclosed method 800 may generally be utilized with any suitable gas turbine and/or may be utilized in connection with a system having any other suitable system configuration. In addition, although FIG. 8 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

In exemplary embodiments, the method 800 includes at (802) monitoring, with a controller 200, data indicative of one or more particulate parameters with a particulate sensor 112. The particulate sensor 112 may be disposed in at least one of an inlet 15 to the compressor section 14 or an outlet 19 of the turbine section 18. The particulate parameters may include particulate type (e.g., sand, dirt, dust, etc.), particulate size, amount (or concentration) of particulate entering the compressor section 14 (e.g., the amount of particulate present in the air entering the compressor section 14), amount (or concentration) of particulate exiting the turbine section 18 (the amount of particulate present in the exhaust gas exiting the turbine section 18).

In many implementations, the method 800 may further include at (804) determining, with the controller 200, when the data indicative of one or more particulate parameters exceeds a particulate threshold. The particulate threshold may include a threshold for each of the particulate parameters (e.g., particulate type threshold, particulate size threshold, particulate amount threshold), such that the controller 200 may determine that the only one of the particulate parameters exceeds the particulate size threshold while the others do not.

In exemplary implementations, the method 800 may further include at (806) implementing a control action associated with a wash system 102 in response to determining that the data indicative of one or more particulate parameters exceeds a particulate threshold. For example, the one or more control actions may include initiating an online wash of the gas turbine 10 with the wash system 102, shutting down the gas turbine 10 for an offline wash, and/or optimizing the wash agent (or detergent) mixture used in the online and/or offline wash. Optimizing the wash agent (or detergent) mixture may include adjusting the amount (or a concentration) of the agent (or detergent) mixed with the water based on the intensity of the wash that is necessary. As such, control action may include adjusting a concentration of detergent in a cleaning fluid used by the wash system.

In many embodiments, depending on the frequency in which the system 100 is implementing an online water wash in response to the particulate parameters exceeding a threshold, the wash system 102 may increase the concentration of detergent in the cleaning fluid, to increase the effectiveness of each online wash and reduce the frequency of the online washes. For example, if the frequency of online washes exceeds a frequency threshold, then the wash system 102 may increase a concentration of the detergent in the cleaning fluid used by the wash system. Additionally, or alternatively, if the frequency of online washes exceeds the frequency threshold, then the controller may generate a notification that a compressor inspection is necessary due to excessive fouling (e.g., the compressor finish may have been severely compromised).

In many embodiments, the control action may include adjusting a wash schedule of the gas turbine 10 to minimize down time of the gas turbine 10. The wash schedule may include predetermined dates and times on which the gas turbine is to undergo an online wash or be shut down for an offline wash. The control actions may include adjusting one or more of the predetermined dates and times on which the gas turbine is to undergo an online wash or be shut down for an offline wash based on the one or more sensed particulate parameters. In many embodiments, the control actions may include adjusting (e.g., increasing) a duration of the next online wash based on the sensed particulate parameters.

In various embodiments, the method may include generating a notification to indicate that a maintenance action is needed for the gas turbine. The notification may be generated in response to one or more sensed particulate parameters. The maintenance action may include a filter house inspection, an offline water wash, replacing a component of the gas turbine, or others. For example, if the controller determines that there is an increased particulate ingress and/or that the pressure differential of the filters 122, 124 in the filter house 120 has dropped, then the controller may generate a notification to inspect the filter house 120 for a breach (i.e., a failure) in one of the filters 122, 124.

In many embodiments, the method 800 may include a first particulate threshold and a second particulate threshold, and the second particulate threshold may be greater than the first particulate threshold, such that the controller 200 can determine the severity of the control action necessary based on where the sensed data indicative of one or more particulate parameters falls relative to the first particulate threshold and the second particulate threshold. For example, if the controller determines that the data indicative of one or more particulate parameters exceeds the first particulate threshold (but falls below the second particulate threshold), then the controller 200 may implement an online wash with the wash system 102. Further, if the controller determines that the data indicative of one or more particulate parameters exceeds the first particulate threshold and the second particulate threshold, then the controller 200 may shut down the gas turbine 10 and implement an offline wash with the wash system 102 (or schedule an offline wash).

Additionally, in some implementations, determining at (804) may be over a time period, such that outlying events (such as a spike in one or more particulate parameters) may be filtered out. In such implementations, the one or more particulate parameters must exceed the threshold over the entire time period in order for the controller to implement the control action at (806).

In some implementations, the method 800 may further include determining, with the one or more models 202, at least one of a fouling rate, a deposition rate, and a degradation rate associated with one or more components of the gas turbine based on the one or more particulate parameters. In such implementations, the method 800 may include implementing the control action associated with a wash system based on a magnitude of at least one of the fouling rate, the deposition rate, and the degradation rate. For example, the controller 200 may include a first rate threshold and a second rate threshold for each of the fouling rate, the degradation rate, and the deposition rate. The first rate threshold may be smaller than the second rate threshold.

In many implementations, the method 800 may include determining, with the controller, when one of the fouling rate, deposition rate, or degradation rate exceeds the first rate threshold and falls below the second rate threshold. In such implementations, the method 800 may include performing an online wash of the gas turbine with the wash system 102 in response to determining that one of fouling rate, deposition rate, or degradation rate exceeds a first rate threshold and falls below a second rate threshold. Additionally, in exemplary implementations, the method 800 may include determining, with the controller 200, when one of the fouling rate, deposition rate, or degradation rate exceeds the first rate threshold and exceeds the second rate threshold. In response, the method may include shutting down the gas turbine and performing an offline wash of the gas turbine with the wash system.

In many embodiments, an environmental sensor 128 may be disposed outside of the gas turbine 10. the environmental sensor 128 may be communicatively coupled to the controller 200 and configured to provide data indicative of harsh weather conditions. In such embodiments, the method 800 may further include implementing the control action associated with the wash system 102 based on the data indicative of harsh weather conditions. The data indicative of harsh weather conditions may include parameters associated with particulate in the ambient environment surrounding the gas turbine 10, such as amount of particulate in the air (which may increase/decrease with weather conditions), type of particulate in the air (e.g., sand, dust, dirt, etc.), size of particulate in the air, and other parameters. The controller 200 may include a first harsh weather threshold and a second harsh weather threshold. The second harsh weather threshold may be greater than the first harsh weather threshold.

In exemplary embodiments, the method 800 may include determining, with the controller 200, when the data indicative of harsh weather conditions exceeds the first harsh weather threshold and falls below the second harsh weather threshold. In response, the method 800 may include performing an online wash of the gas turbine with the wash system. Additionally, the method 800 may include determining, with the controller 200, when the data indicative of harsh weather conditions exceeds the first harsh weather threshold and exceeds the second harsh weather threshold. In response, the method may include shutting down the gas turbine performing an offline wash of the gas turbine with the wash system.

In various embodiments, the system 100 may include an extraction cooling pipe 130 extending between the compressor section 14 and the turbine section 18. For example, the extraction cooling pipe may fluidly couple the compressor section 14 and the turbine section 18. the extraction cooling pipe 130 may be configured to convey bleed air from the compressor section 14 to the turbine section 18 for use in one or more turbine components (e.g., for cooling the turbine components). A contamination sensor 132 may be disposed in the extraction cooling pipe 130 and configured to provide data indicative of particulate contamination in the bleed air. In such embodiments, the method 800 may include implementing the control action associated with the wash system 102 based on the data indicative of particulate contamination in the bleed air. For example, the controller may include (e.g., stored in the memory) a first contamination threshold and a second contamination threshold. The second contamination threshold may be greater than the first contamination threshold.

In exemplary implementations, the method 800 may include determining, with the controller 200, when the data indicative particulate contamination in the bleed air exceeds the first contamination threshold and falls below the second contamination threshold. In response, the method 800 may include performing an online wash of the gas turbine with the wash system 102. Additionally, the method 800 may include determining, with the controller, when the data indicative particulate contamination in the bleed air exceeds the first contamination threshold and exceeds the second contamination threshold. In response, the method 800 may include shutting down the gas turbine 10 and performing an offline wash of the gas turbine with the wash system.

In many embodiments, the system 100 may include a particulate sensor 112A disposed at the inlet 15 of the compressor section 14 and a particulate sensor 112B disposed at the outlet of the turbine section 18. In some instances, the particulate sensor 112A may not measure particulate ingress to the compressor section 14 (e.g., no sand, dirt, dust, etc. is entering the gas turbine), but the sensor 112B does measure particulate egress from the turbine section 18. In such instances, the controller 200 may determine that incomplete consumption of fuel is taking place in the combustion section 16 resulting in soot exiting the turbine section 18 (and potentially building up in the turbine section 18 impacting efficiency). Alternatively, or additionally, based on the particulate egress from the turbine section 18 (e.g., soot exiting the turbine section 18), the controller 200 may determine that the fuel system 134 has been breached (i.e., the fuel supply 137 and/or fuel lines 139 have failed), and the controller 200 may generate an inspection notification (which may be supplied to the user interface 220). For example, If the inlet monitoring system is indicating that the gas turbine system is operating within normal parameters and the outlet monitoring system detects debris via the exhaust sensors, this will be indicative of a compromised/contaminated fuel system/breach.

The system 100 and method 800 described herein may advantageously reduce gas turbine 10 down time by actively responding to particulate ingress/egress in the gas turbine 10 with the wash system 102. For example, by timely addressing particulate ingress/egress in the gas turbine 10, the number offline washes can be reduced (thereby reducing down-time), and the overall operating efficiency of the gas turbine 10 can be increased by ensuring that the gas turbine 10 is operating at full capacity without any particulate buildup in the compressor section 14 and/or the turbine section 18.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A method for timely addressing particulates in a gas turbine, the gas turbine comprising a compressor section, a combustion section, and a turbine section, the method comprising: monitoring, with a controller, data indicative of one or more particulate parameters with a particulate sensor, the particulate sensor disposed in at least one of an inlet to the compressor section or an outlet of the turbine section; determining, with the controller, when the data indicative of one or more particulate parameters exceeds a particulate threshold; and implementing a control action associated with a wash system in response to determining that the data indicative of one or more particulate parameters exceeds the particulate threshold.

The method as in one or more of these clauses, further comprising: determining, with one or more models, at least one of a fouling rate, a deposition rate, and a degradation rate associated with one or more components of the gas turbine based on the data indicative of one or more particulate parameters; and implementing the control action associated with a wash system based on a magnitude of at least one of the fouling rate, the deposition rate, and the degradation rate.

The method as in one or more of these clauses, further comprising: determining, with the controller, when one of the fouling rate, deposition rate, or degradation rate exceeds a first rate threshold and falls below a second rate threshold; and performing an online wash of the gas turbine with the wash system in response to determining that one of fouling rate, deposition rate, or degradation rate exceeds a first rate threshold and falls below a second rate threshold.

The method as in one or more of these clauses, further comprising: determining, with the controller, when one of the fouling rate, deposition rate, or degradation rate exceeds the first rate threshold and exceeds the second rate threshold; shutting down the gas turbine; and performing an offline wash of the gas turbine with the wash system in response to determining that one of fouling rate, deposition rate, or degradation rate exceeds the first rate threshold and exceeds the second rate threshold.

The method as in one or more of these clauses, further comprising an environmental sensor disposed outside of the gas turbine, the environmental sensor communicatively coupled to the controller and configured to provide data indicative of harsh weather conditions, wherein the method further comprises: implementing the control action associated with the wash system based on the data indicative of harsh weather conditions.

The method as in one or more of these clauses, further comprising: determining, with the controller, when the data indicative of harsh weather conditions exceeds a first harsh weather threshold and falls below a second harsh weather threshold; and performing an online wash of the gas turbine with the wash system in response to determining that the data indicative of harsh weather conditions exceeds the first harsh weather threshold and falls below the second harsh weather threshold.

The method as in one or more of these clauses, further comprising: determining, with the controller, when the data indicative of harsh weather conditions exceeds the first harsh weather threshold and exceeds the second harsh weather threshold; shutting down the gas turbine; and performing an offline wash of the gas turbine with the wash system in response to determining that the data indicative of harsh weather conditions exceeds the first harsh weather threshold and exceeds the second harsh weather threshold.

The method as in one or more of these clauses, further comprising an extraction cooling pipe extending between the compressor section and the turbine section, the extraction cooling pipe configured to convey bleed air from the compressor section to the turbine section for use in one or more turbine components, a contamination sensor is disposed in the extraction cooling pipe and configured to provide data indicative of particulate contamination in the bleed air, and wherein method further comprises: implementing the control action associated with the wash system based on the data indicative of particulate contamination in the bleed air.

The method as in one or more of these clauses, further comprising: determining, with the controller, when the data indicative particulate contamination in the bleed air exceeds a first contamination threshold and falls below a second contamination threshold; and performing an online wash of the gas turbine with the wash system in response to determining that the data indicative particulate contamination in the bleed air exceeds the first contamination threshold and falls below the second contamination threshold.

The method as in one or more of these clauses, further comprising: determining, with the controller, when the data indicative particulate contamination in the bleed air exceeds a first contamination threshold and exceeds a second contamination threshold; shutting down the gas turbine; and performing an offline wash of the gas turbine with the wash system in response to determining that the data indicative particulate contamination in the bleed air exceeds the first contamination threshold and exceeds the second contamination threshold.

The method as in one or more of these clauses, wherein the control action comprises generating a notification to indicate that a maintenance action is needed for the gas turbine.

The method as in one or more of these clauses, wherein the control action comprises adjusting a wash schedule of the gas turbine to minimize down time of the gas turbine.

The method as in one or more of these clauses, wherein the control action comprises adjusting a concentration of detergent in a cleaning fluid used by the wash system.

A system comprising: a gas turbine including a compressor section, a combustion section, and a turbine section; a wash system fluidly coupled to the gas turbine; a particulate sensor disposed in at least one of an inlet to the compressor section or an outlet of the turbine section, the particulate sensor configured to provide data indicative of one or more particulate parameters; and a controller communicatively coupled to the wash system and the particulate sensor, the controller comprising a memory and at least one processor, the at least one processor configured to perform a plurality of operations, the plurality of operations comprising: monitoring, with the controller, the data indicative of one or more particulate parameters from the particulate sensor; determining, with the controller, when the data indicative of one or more particulate parameters exceeds a particulate threshold; and implementing a control action associated with the wash system in response to determining that the data indicative of one or more particulate parameters exceeds the particulate threshold.

The system as in one or more of these clauses, wherein the plurality of operations further comprises: determining, with one or more models, at least one of a fouling rate, a deposition rate, and a degradation rate associated with one or more components of the gas turbine based on the data indicative of one or more particulate parameters; and implementing the control action associated with a wash system based on a magnitude of at least one of the fouling rate, the deposition rate, and the degradation rate.

The system as in one or more of these clauses, further comprising: determining, with the controller, when one of the fouling rate, deposition rate, or degradation rate exceeds a first rate threshold and falls below a second rate threshold; and performing an online wash of the gas turbine with the wash system in response to determining that one of fouling rate, deposition rate, or degradation rate exceeds a first rate threshold and falls below a second rate threshold.

The system as in one or more of these clauses, further comprising: determining, with the controller, when one of the fouling rate, deposition rate, or degradation rate exceeds the first rate threshold and exceeds the second rate threshold; shutting down the gas turbine; and performing an offline wash of the gas turbine with the wash system in response to determining that one of fouling rate, deposition rate, or degradation rate exceeds the first rate threshold and exceeds the second rate threshold.

The system as in one or more of these clauses, further comprising an environmental sensor disposed outside of the gas turbine, the environmental sensor communicatively coupled to the controller and configured to provide data indicative of harsh weather conditions, wherein the plurality of operations further comprises: implementing the control action associated with the wash system based on the data indicative of harsh weather conditions.

The system as in one or more of these clauses, further comprising: determining, with the controller, when the data indicative of harsh weather conditions exceeds a first harsh weather threshold and falls below a second harsh weather threshold; and performing an online wash of the gas turbine with the wash system in response to determining that the data indicative of harsh weather conditions exceeds the first harsh weather threshold and falls below the second harsh weather threshold.

The system as in one or more of these clauses, further comprising: determining, with the controller, when the data indicative of harsh weather conditions exceeds the first harsh weather threshold and exceeds the second harsh weather threshold; shutting down the gas turbine; and performing an offline wash of the gas turbine with the wash system in response to determining that the data indicative of harsh weather conditions exceeds the first harsh weather threshold and exceeds the second harsh weather threshold.

What is claimed is:

1. A method for timely addressing particulates in a gas turbine, the gas turbine comprising a compressor section, a combustion section, and a turbine section, the method comprising:
monitoring, with a controller, data indicative of one or more particulate parameters with a particulate sensor, the particulate sensor disposed in at least one of an inlet to the compressor section or an outlet of the turbine section;
determining, with the controller, when the data indicative of one or more particulate parameters exceeds a particulate threshold; and
implementing a control action associated with a wash system in response to determining that the data indicative of one or more particulate parameters exceeds the particulate threshold.

2. The method as in claim 1, further comprising:
determining, with one or more models, at least one of a fouling rate, a deposition rate, and a degradation rate associated with one or more components of the gas turbine based on the data indicative of one or more particulate parameters; and
implementing the control action associated with a wash system based on a magnitude of at least one of the fouling rate, the deposition rate, and the degradation rate.

3. The method as in claim 2, further comprising:
determining, with the controller, when one of the fouling rate, deposition rate, or degradation rate exceeds a first rate threshold and falls below a second rate threshold; and
performing an online wash of the gas turbine with the wash system in response to determining that one of fouling rate, deposition rate, or degradation rate exceeds a first rate threshold and falls below a second rate threshold.

4. The method as in claim 3, further comprising:
determining, with the controller, when one of the fouling rate, deposition rate, or degradation rate exceeds the first rate threshold and exceeds the second rate threshold;
shutting down the gas turbine; and
performing an offline wash of the gas turbine with the wash system in response to determining that one of fouling rate, deposition rate, or degradation rate exceeds the first rate threshold and exceeds the second rate threshold.

5. The method as in claim 1, further comprising an environmental sensor disposed outside of the gas turbine, the environmental sensor communicatively coupled to the controller and configured to provide data indicative of harsh weather conditions, wherein the method further comprises:
implementing the control action associated with the wash system based on the data indicative of harsh weather conditions.

6. The method as in claim 5, further comprising:
determining, with the controller, when the data indicative of harsh weather conditions exceeds a first harsh weather threshold and falls below a second harsh weather threshold; and
performing an online wash of the gas turbine with the wash system in response to determining that the data indicative of harsh weather conditions exceeds the first harsh weather threshold and falls below the second harsh weather threshold.

7. The method as in claim 6, further comprising:
determining, with the controller, when the data indicative of harsh weather conditions exceeds the first harsh weather threshold and exceeds the second harsh weather threshold;
shutting down the gas turbine; and
performing an offline wash of the gas turbine with the wash system in response to determining that the data indicative of harsh weather conditions exceeds the first harsh weather threshold and exceeds the second harsh weather threshold.

8. The method as in claim 1, further comprising an extraction cooling pipe extending between the compressor section and the turbine section, the extraction cooling pipe configured to convey bleed air from the compressor section to the turbine section for use in one or more turbine components, a contamination sensor is disposed in the extraction cooling pipe and configured to provide data indicative of particulate contamination in the bleed air, and wherein method further comprises:
implementing the control action associated with the wash system based on the data indicative of particulate contamination in the bleed air.

9. The method as in claim 8, further comprising:
determining, with the controller, when the data indicative particulate contamination in the bleed air exceeds a first contamination threshold and falls below a second contamination threshold; and
performing an online wash of the gas turbine with the wash system in response to determining that the data indicative particulate contamination in the bleed air exceeds the first contamination threshold and falls below the second contamination threshold.

10. The method as in claim 9, further comprising:
determining, with the controller, when the data indicative particulate contamination in the bleed air exceeds a first contamination threshold and exceeds a second contamination threshold;
shutting down the gas turbine; and
performing an offline wash of the gas turbine with the wash system in response to determining that the data indicative particulate contamination in the bleed air exceeds the first contamination threshold and exceeds the second contamination threshold.

11. The method as in claim 1, wherein the control action comprises generating a notification to indicate that a maintenance action is needed for the gas turbine.

12. The method as in claim 1, wherein the control action comprises adjusting a wash schedule of the gas turbine to minimize down time of the gas turbine.

13. The method as in claim 1, wherein the control action comprises adjusting a concentration of detergent in a cleaning fluid used by the wash system.

14. A system comprising:
a gas turbine including a compressor section, a combustion section, and a turbine section;
a wash system fluidly coupled to the gas turbine;
a particulate sensor disposed in at least one of an inlet to the compressor section or an outlet of the turbine section, the particulate sensor configured to provide data indicative of one or more particulate parameters; and
a controller communicatively coupled to the wash system and the particulate sensor, the controller comprising a memory and at least one processor, the at least one processor configured to perform a plurality of operations, the plurality of operations comprising:
monitoring, with the controller, the data indicative of one or more particulate parameters from the particulate sensor;
determining, with the controller, when the data indicative of one or more particulate parameters exceeds a particulate threshold; and
implementing a control action associated with the wash system in response to determining that the data indicative of one or more particulate parameters exceeds the particulate threshold.

15. The system as in claim 14, wherein the plurality of operations further comprises:
determining, with one or more models, at least one of a fouling rate, a deposition rate, and a degradation rate associated with one or more components of the gas turbine based on the data indicative of one or more particulate parameters; and
implementing the control action associated with a wash system based on a magnitude of at least one of the fouling rate, the deposition rate, and the degradation rate.

16. The system as in claim 15, further comprising:
determining, with the controller, when one of the fouling rate, deposition rate, or degradation rate exceeds a first rate threshold and falls below a second rate threshold; and
performing an online wash of the gas turbine with the wash system in response to determining that one of fouling rate, deposition rate, or degradation rate exceeds a first rate threshold and falls below a second rate threshold.

17. The system as in claim 16, further comprising:
determining, with the controller, when one of the fouling rate, deposition rate, or degradation rate exceeds the first rate threshold and exceeds the second rate threshold;
shutting down the gas turbine; and
performing an offline wash of the gas turbine with the wash system in response to determining that one of fouling rate, deposition rate, or degradation rate exceeds the first rate threshold and exceeds the second rate threshold.

18. The system as in claim 14, further comprising an environmental sensor disposed outside of the gas turbine, the environmental sensor communicatively coupled to the controller and configured to provide data indicative of harsh weather conditions, wherein the plurality of operations further comprises:
implementing the control action associated with the wash system based on the data indicative of harsh weather conditions.

19. The system as in claim 18, further comprising:
determining, with the controller, when the data indicative of harsh weather conditions exceeds a first harsh weather threshold and falls below a second harsh weather threshold; and
performing an online wash of the gas turbine with the wash system in response to determining that the data indicative of harsh weather conditions exceeds the first harsh weather threshold and falls below the second harsh weather threshold.

20. The system as in claim 19, further comprising:
determining, with the controller, when the data indicative of harsh weather conditions exceeds the first harsh weather threshold and exceeds the second harsh weather threshold;
shutting down the gas turbine; and
performing an offline wash of the gas turbine with the wash system in response to determining that the data indicative of harsh weather conditions exceeds the first harsh weather threshold and exceeds the second harsh weather threshold.
